(19) United States
(12) Patent Application Publication
(10) Pub. No.: US 2009/0153497 A1
(43) Pub. Date: Jun. 18, 2009

(54) USER INTERFACE DEVICE AND INPUT ELEMENT

(75) Inventors: Han-chul Jung, Seoul (KR); Chang-su Kim, Suwon-si (KR); O-jae Kwon, Seoul (KR); Chang-beom Shin, Seoul (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/164,397

(22) Filed: Jun. 30, 2008

(30) Foreign Application Priority Data
Dec. 14, 2007 (KR) 2007-131082

(51) Int. Cl. G06F 3/041

(52) U.S. Cl. 345/173

(57) ABSTRACT

A user interface device and an input element include at least one input button that protrudes to be deformed when being pressed and then elastically restored when not being pressed, a sensing unit to sense whether the at least one input button has been pressed, and a display panel disposed underneath the at least one input button and including an input sign display area overlapping with the at least one input button.

### CROSS-REFERENCE TO RELATED APPLICATION

This application claims the benefit of Korean Application No. 2007-131082, filed Dec. 14, 2007 in the Korean Intellectual Property Office, the disclosure of which is incorporated herein by reference.

### BACKGROUND OF THE INVENTION

1. Field of the Invention

Aspects of the present invention relate to a user interface device, and more particularly, to a user interface device for assisting a user to tactually recognize a selected input, and an input element thereof.

2. Description of the Related Art

User interface devices using input buttons (such as keyboards, keypads, remote controllers, etc.) are used with electronic devices that includes computers, televisions (TVs), mobile phones, etc. In addition, touch sensitive user interface devices (such as touch screens, touch sensors, etc.) have been widely used. However, such touch sensitive user interface devices cannot recognize that a user is correctly manipulating the touch sensitive user interface devices as desired by the user. Therefore, user conveniences of the touch sensitive user interface devices have been degraded. In other words, when the user interface devices, including the touch sensitive user interface devices, are manipulated by users, the user interface devices do not provide a tactual reaction or feedback in response to the users' manipulations. If an electronic device does not operate after the manipulation thereof by the user, the user does not know whether the user is incorrectly manipulating the electronic device or whether the electronic device is out of order. Hence, the user may be very confused and inconvenienced if the user interface devices do not provide the tactual reaction or feedback to the users' manipulations.

User interface devices that provide a vibration feedback have been developed in order to solve the above-described problems. However, since such user interface devices have complicated structures, they have increased manufacturing costs, and decreased reliability. Also, since the user interface devices cannot provide users with a tactual feedback when the users press input buttons thereof, even users familiar with use of input button cannot easily recognize their inputs.

### SUMMARY OF THE INVENTION

Aspects of the present invention provides a user interface device to provide a user with a tactual feedback when the user presses an input button in order to assist the user to recognize that the user is manipulating the user interface device, and an input element thereof.

According to an aspect of the present invention, a user interface device includes: at least one input button that protrudes to be deformed when pressed, and then elastically restored when no longer being pressed; a sensing unit to sense whether the at least one input button has been pressed; and a display panel disposed underneath the at least one input button and including an input sign display area that overlaps with f the at least one input button, and which is viewable through the at least one input button.

According to an aspect of the present invention, the sensing unit may include a piezoelectric element and/or a bending sensor that is attached to the at least one input button.

According to an aspect of the present invention, the sensing unit may be formed from a pair of transparent resistive layers on corresponding inner surfaces of a pair of parallel flexible films and face each other, and the pair of parallel flexible films are separated from each other so as to contact each other at a pressed point when pressed together due to a pressure.

According to an aspect of the present invention, the sensing unit may include a pair of transparent electrode layers separated by a flexible film whose capacitance is changed when the transparent electrode layers are pressed together.

According to an aspect of the present invention, the input sign display area may display an image, which is changed when the at least one input button is pressed.

According to an aspect of the present invention, the display panel may be a liquid crystal display (LCD) panel, an organic light emitting diode (OLED) panel, e-paper, or combinations thereof.

According to an aspect of the present invention, the at least one input button may be a polymer.

According to another aspect of the present invention, an input element mounted on a circuit board of an electronic device includes: at least one input button that protrudes to be deformed when pressed and then elastically restored when no longer being pressed; a sensing unit to sense whether the at least one input button has been pressed; and a display panel disposed underneath the at least one input button to overlap with the at least one input button and to change an image that is displayed when the at least one input button is pressed, and which is viewable through the at least one input button.

According to another aspect of the present invention, a flexible sheet includes a deformable input button; a sensing unit attached to the at least one input button to sense whether the at least one input button is deformed; and a display panel disposed adjacent to the flexible sheet, the display panel comprising at least one input sign display area that corresponds to the at least one input button, and which displays an input image viewable through the least one input button.

According to another aspect of the present invention, a method of selecting an input image using an input button includes: displaying the input image on a display panel to be viewed through the input button; selectively deforming the input button to select the input image; switching the display of the input image to display another input image on the display panel to be viewed through the input button; and selectively deforming the input button to select the another input image.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects, taken in conjunction with the accompanying drawings of which:

FIG. 1 illustrates a user interface device and an electronic device operated through a manipulation of the user interface device, according to an aspect of the present invention;

FIG. 2 is a cross-sectional view taken along line II-II of FIG. 1;

FIG. 3 is a block diagram to illustrate a signal processing flow between the user interface device and the electronic device illustrated in FIG. 1;

FIGS. 4A and 4B are plan views of the user interface device of FIG. 1 to illustrate a change in input signs from that shown in FIG. 4A into input signs shown in FIG. 4B when an input button that switches the input signs is pressed;

FIG. 5A is a cross-sectional view of a user interface device according to another aspect of the present invention;

FIG. 5B is a plan view of a portion of the user interface device of FIG. 5A;

FIG. 6 is a cross-sectional view of a user interface device according to another aspect of the present invention;

FIGS. 7A and 7B are alternative cross-sectional views magnifying portion VII of the user interface device of FIG. 6, according to aspects of the present invention; and

FIG. 8 is a cross-sectional view of an input element according to an aspect of the present invention.

### DETAILED DESCRIPTION OF THE EMBODIMENTS

Reference will now be made in detail to aspects of the present invention, examples of which are illustrated in the accompanying drawings, wherein like reference numerals refer to the like elements throughout. The aspects are described below in order to explain the present invention by referring to the figures.

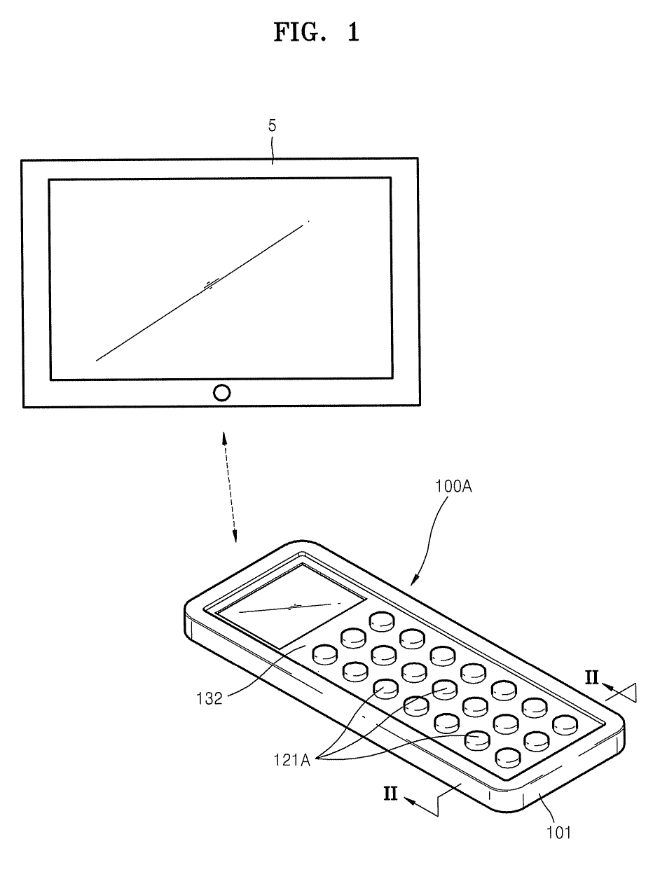

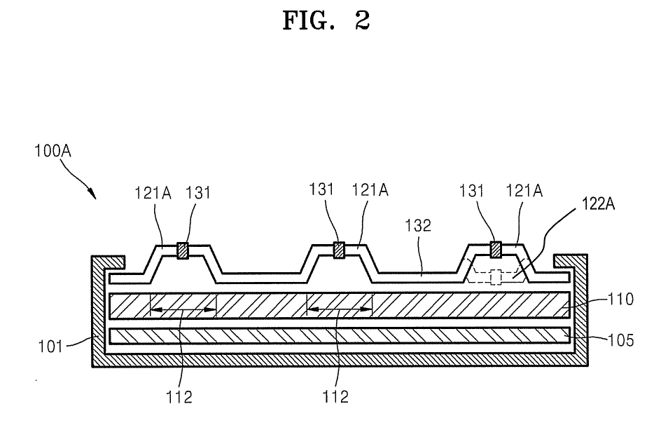

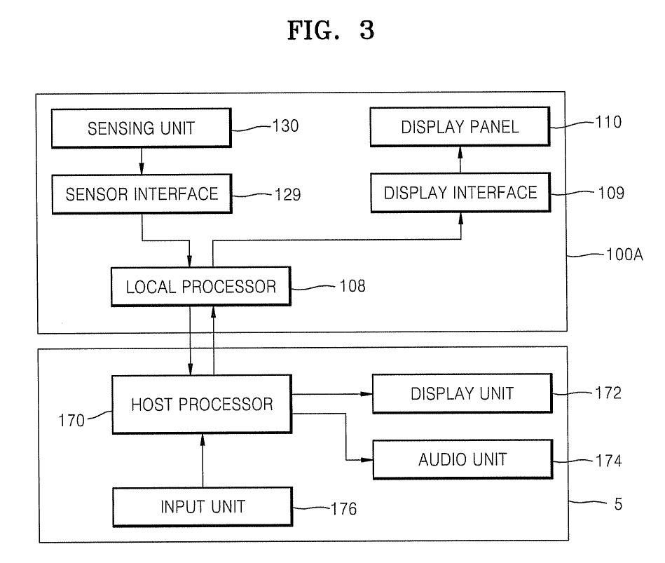

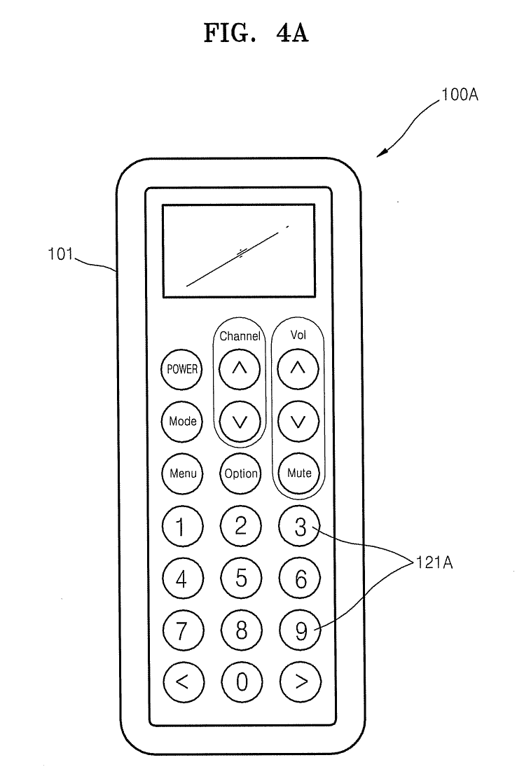

FIG. 1 illustrates a user interface device 100A, and an electronic device 5 which is operated through a manipulation of the user interface device 100A, according to an aspect of the present invention. FIG. 2 is a cross-sectional view taken along line II-II of FIG. 1. FIG. 3 is a block diagram to illustrate a signal processing flow between the user interface device 100A, and the electronic device 5 illustrated in FIG. 1. FIGS. 4A and 4B are plan views of the user interface device 100A of FIG. 1 to illustrate a change in input signs from those shown in FIG. 4A into input signs shown in FIG. 4B when an input button that switches the input signs is pressed.

Referring to FIGS. 1 through 3, a user interface device 100A according to an aspect of the present invention is a remote controller type device to operate an electronic device 5, an example being a television (TV). The user interface device 100A includes input buttons 121A, a display panel 110 disposed underneath the input buttons 121A to overlap with the input buttons 121A, a circuit board 105, and a housing 101 that includes the display panel 110 and the circuit board 105.

The input buttons 121A are formed in predetermined areas of a transparent flexible film 132 that is formed of a polymer or polymers, and the number of input buttons 121A is at least one or more. Also, the input buttons 121A keep protruding outward when not pressed. However, when the input buttons 121A are pressed, the input buttons 121A are deformed and pushed inward as shown by the broken lines 122A. The input buttons 121A are immediately and elastically restored when the input buttons 121A is not pressed. A sensing unit 130 is formed at the transparent flexible film 132 to sense whether the input buttons 121A have been pressed. The sensing unit 130 includes piezoelectric elements 131 that are respectively attached to centers of the input buttons 121A. In other aspects of the present invention, the piezoelectric elements 131 may be attached to any location in the input buttons 121A. Additionally, in aspects of the present invention, the flexible film 132 may include non-transparent areas. For example, areas other than the input buttons 121A or portions of the input button 121A may be opaque. Further, the input buttons 121A need not be immediately restored in all aspects.

If one of the input buttons 121A is pressed as shown with the broken line 122B of FIG. 2, a corresponding one of the piezoelectric elements 131 generates an electric signal by a pressure on the input button 121A. Therefore, determination as to which one of the input buttons 121A has been pressed can be made. The piezoelectric elements 131 may be small elements each having a diameter of not less than 1 mm, so as to enable identification of images that are displayed in input sign display areas 112 of the display panel 110 even when the piezoelectric elements 131 are attached to the input buttons 121A so as to allow view of the input sign display areas 112 through the input buttons 121A. In other aspects of the present invention, the diameter of the piezoelectric elements 131 may be smaller than 1 mm, and the input buttons 121A need not be circular and can be other shapes, such as a rectilinear shape.

The display panel 110 includes the input sign display areas 112 that overlap and/or correspond with the input buttons 121A. Each of the input sign display areas 112 may display various kinds of signs (e.g., [symbol] , ▪, >, <, etc.) corresponding to various input orders or functions thereof, such as those commonly used in a remote controller, a telephone, a handheld device, a digital media player, or similar devices. The display panel 110 may be a liquid crystal display (LCD) panel, an organic light emitting diode (OLED) panel, e-paper, etc. However, since displayed signs are relatively simple, the e-paper may be used as the display panel 110 in consideration of cost, though this is not required.

The display panel 110 is shown mounted on the circuit board 105. The circuit board 105 includes a local processor 108 that processes electric signals generated by the piezoelectric elements 131 and a sensor interface 129 that is used for communications between a host processor 170 of the TV 5 (hereinafter referred to as the electronic device for convenience) and the sensing unit 130. The circuit board 105 also includes a display interface 109 that is used for communications between the display panel 110 and the host processor 170 of the electronic device 5. In aspects of the present invention, the communications between the host processor 170 and the sensing unit 130 or between the host processor 170 and the display panel 110 are via the local processor 108. Further, the display panel 110 can be otherwise connected to the circuit board 105, and the processor 108 can be otherwise disposed. Thus, the electronic device 5 is not used in all aspects.

If one of the input buttons 121A of the user interface device 100A is pressed, the sensing unit 130 including the piezoelectric elements 131 generates an electric signal and transmits the electric signal to the host processor 170 through the sensor interface 129 and the local processor 108. That is, the sensor interface 129 converts the electric signal generated by the sensing unit 130 into a signal that may be processed by the local processor 108, and the local processor 108 processes the signal and then transmits the signal to the host processor 170.

The host processor 170 determines which one of the input buttons 121A has been clicked or pressed based on the signal transmitted from the local processor 108. The host processor 170 can also transmit a signal to the user interface device 100A to change a display of the display panel 110 according to an input signal based on user input or pressing of one of the input buttons 121A. The host processor 170 transmits other signals to a display unit 172 and an audio unit 174 to operate the display unit 172 and the audio unit 174 so as to realize a function of the input signal. Here, the display unit 172 includes a display panel of the electronic device 5, and the audio unit 174 includes a speaker of the electronic device 5, for example. Reference numeral 176 refers to another input unit that can operate the electronic device 5 besides the user interface device 100A.

After the user interface device 100A is turned on, signs (or graphic symbols, including letters, numbers, small images, icons, colors, and/or other indicia) symbolizing selectable input orders may be respectively displayed through the input buttons 121A of the user interface device 100A at a time, such as shown in FIG. 4A. That is, input sign display areas 112 of the display panel 110 display the signs, for example, whose images are shown through the respective input buttons 121A. However, if a predetermined one of the input buttons 121A (e.g., an input button of sign “>” indicating a right arrow, for example) is pressed, which indicates selection of next group of signs, images displayed in the input sign display areas 112 of the display panel 110 are changed. Thus, signs for letters shown in FIG. 4B appear on a few of the input buttons 121A which had previously displayed signs for numbers. In other words, input buttons displaying numbers are changed into input buttons displaying letters of the alphabet. In aspects of the present invention, the input button of sign “>” can be pressed again to display other signs (or button menus). In aspects of the present invention, continue pressing of the input button of sign “>” may circle back to the original displayed signs, such as the numbers shown in FIG. 4A. Also, pressing of the input button of sign “<” will also display the other signs (or the button menus), but in a reverse order, for example. In various aspects, text signs, such as “next” or “previous” may be used, instead of the signs “>” or “<”.

Therefore, each input button is associated with a sign or an input order one at a time. Thus, even if an input button is used to input several signs or types of orders, since association of each input button with several signs or types of orders occurs one at a time, each input button is clearly associated with one particular sign or an input order one at a time. Thus, weakening association of an input button with an input order, which results from printing a plurality of signs corresponding to a plurality of input orders on the input button, may be prevented or lessened. In other words, only one sign appears on each of the input buttons 121A at a time, and thus, input orders may be accurately input through the input buttons 121A. Accordingly, each input button need not be required to serve simultaneously as an input button for a plurality of functions, such as is the case with a cell phone button, which often serves to input three letters simultaneously. Instead, in aspects of the present invention, one or all of the input buttons 121A serve as an input button for a single sign or a single input order one at a time, but is still able to serve as an input button for a plurality of input orders or signs as long as the signs or input orders are changed in a corresponding one of the underlying input sign display areas 112 of the display panel 110.

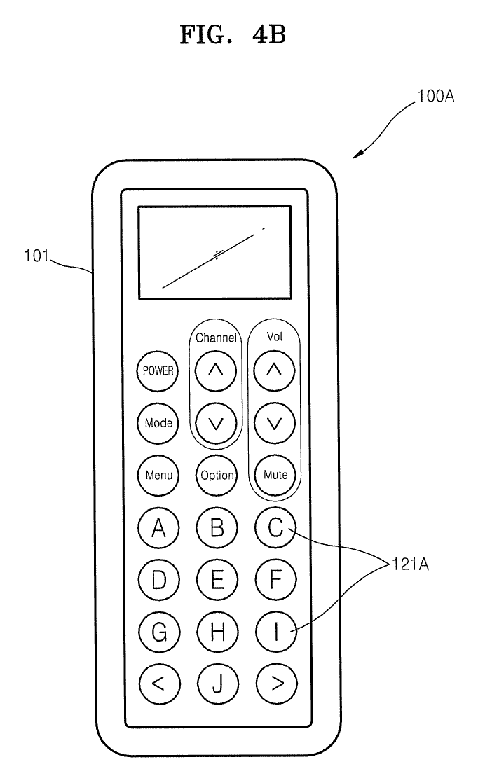

FIG. 5A is a cross-sectional view of a user interface device 100B according to another aspect of the present invention, and FIG. 5B is a plan view of a portion of the user interface device 100B of FIG. 5A. A user interface device 100B may be a remote controller type device like the user interface device 100A illustrated in FIGS. 1 and 2. Thus, same reference numerals of the user interface device 100B as those of the user interface device 100A denote the same elements, and their detailed descriptions will be omitted herein.

Referring to FIGS. 5A and 5B, and FIG. 3, the user interface device 100B includes input buttons 121B, a display panel 110 disposed underneath the input buttons 121B to overlap with the input buttons 121B, a circuit board 105, and a housing including the display panel 110 and the circuit board 105. The input buttons 121B are formed in predetermined areas of a transparent flexible film 136 that is formed of a polymer or polymers, and the number of input buttons 121B is at least one or more. Also, the input buttons 121B keep protruding from the transparent flexible film 136 when not pressed. However, when the input buttons 121A are pressed, the input buttons 121A are deformed. The input buttons 121B are immediately and elastically restored once they are no longer pressed. The sensing unit 130 is formed at the transparent flexible film 136 to sense whether the input buttons 121B have been pressed. In detail, the sensing unit 130 includes bending sensors 135 that are respectively attached to the input buttons 121B. The bending sensors 135 are attached to an inner surface of the transparent flexible film 136. In aspects of the present invention, some portions of the flexible film 136 may be non-transparent.

If one of the input buttons 121B is pressed as shown with broken lines 122B in FIG. 5A, one of the bending sensors 135 is bent to generate an electric signal so as to enable sensing of which one of the input buttons 121B has been pressed. The bending sensors 135 may be formed in a ring shape and positioned at outsides (or peripheries) of the input buttons 121B as shown in FIG. 5B so as to enable identifying of images displayed in the input sign display areas 112 of the display panel 110. That is, the placement and shape of the bending sensors 135 do not block display of the images through the protruding input buttons 121B. A signal processing flow between the user interface device 100B and the electronic device 5 (of FIG. 3) is as described above with reference to FIG. 3, and thus, its detailed description will be omitted herein.

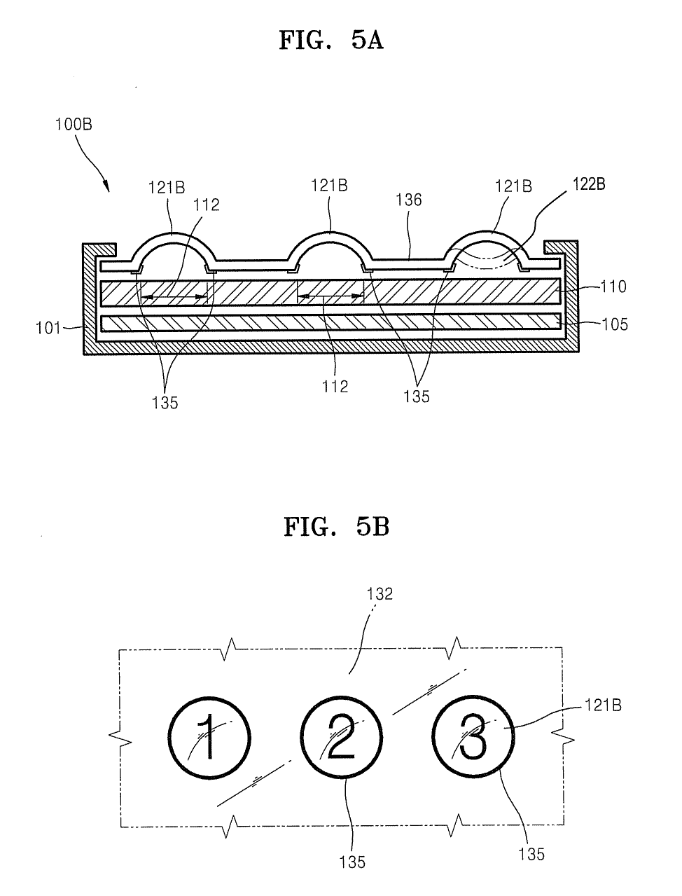

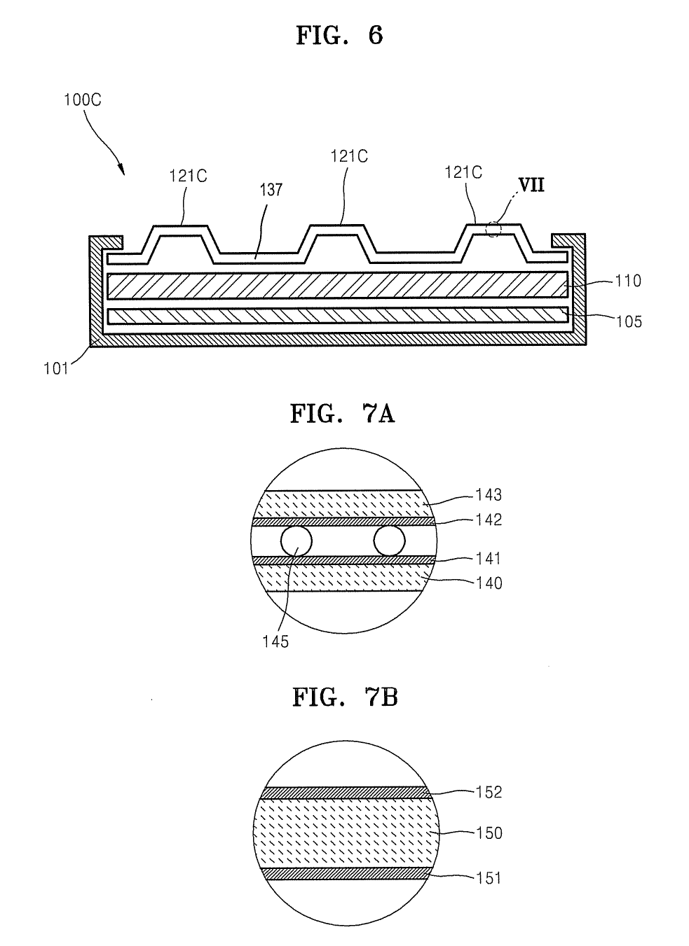

FIG. 6 is a cross-sectional view of a user interface device 100C according to another aspect of the present invention, and FIGS. 7A and 7B are alternative cross-sectional views magnifying portion VII of the user interface device of FIG. 6, according to aspects of the present invention. A user interface device 100C may be a remote controller type device like the user interface device 100A illustrated in FIGS. 1 and 2. The same reference numerals of the user interface device 100C as those of the user interface device 100A denote the same elements, and thus, their detailed descriptions will be omitted herein.

Referring to FIG. 6 and FIG. 3, the user interface device 100C includes input buttons 121C, a display panel 110 disposed underneath the input buttons 121C to overlap with the input buttons 121C, a circuit board 105, and a housing 101 including the display panel 110 and the circuit board 105. The input buttons 121C are formed in predetermined areas a flexible sheet 137. The flexible sheet 137 is formed of one or two (or more) transparent flexible films that are formed of a polymer or polymers, and the number of input buttons 121C is at least one or more. Also, the input buttons 121C keep protruding when not pressed. However, when the input buttons 121C are pressed, the input buttons 121C are deformed, but are immediately and elastically restored when no longer pressed. The sensing unit 130 is formed at the one or two transparent flexible films to sense whether the input buttons 121C have been pressed.

Referring to FIG. 7A, the sensing unit 130 according to an aspect of the present invention includes transparent first and second resistive (or insulative) layers 141 and 142 that are formed on inner surfaces of first and second flexible films 140 and 143 and face each other. Also, the first and second resistive (or insulative) layers 141 and 142 are separated from each other by insulators 145. The first and second flexible films 140 and 143 are parallel with each other. If one of the input buttons 121C is pressed, the first and second resistive (insulative) layers 141 and 142 contact each other and change a resistance thereof so as to enable sensing of which one of the input buttons 121C has been pressed. A sectional structure of the sensing unit of FIG. 7A is similar to a structure of a resistive film type touch pad, and thus, will not be described in further detail. In aspects of the present invention, some portions of the flexible film 137, the first and second resistive (or insulative) layers 141 and 142, and/or the first and second flexible films 140 and 143 may be non-transparent.

Referring to FIG. 7B, and FIG. 3, the sensing unit 130 according to another aspect of the present invention includes transparent first and second electrode (or conductive) layers 151 and 152 that are formed on both sides of a flexible film 150. The first and second electrode layers 151 and 152 may be formed of transparent material such as Tin Antimony Oxide (TAO) (also referred to as Antimony Tin Oxide (ATO)), or other transparent conductive material. If one of the input buttons 121C is pressed, for example, by a part of the body of a person such as a finger, etc., a capacitance between the first and second electrode layers 151 and 152 is changed at a pressed portion of the input button 121C so as to enable sensing as to which one of the input buttons 121C has been pressed. A sectional structure of the sensing unit 130 shown in FIG. 7B is similar to a structure of a capacitive touch pad, and thus, will not be described in further detail. A signal processing flow between the user interface device 100C and the electronic device 5 (of FIG. 3) is as described above with reference to FIG. 3, and thus, its detailed description will be omitted herein.

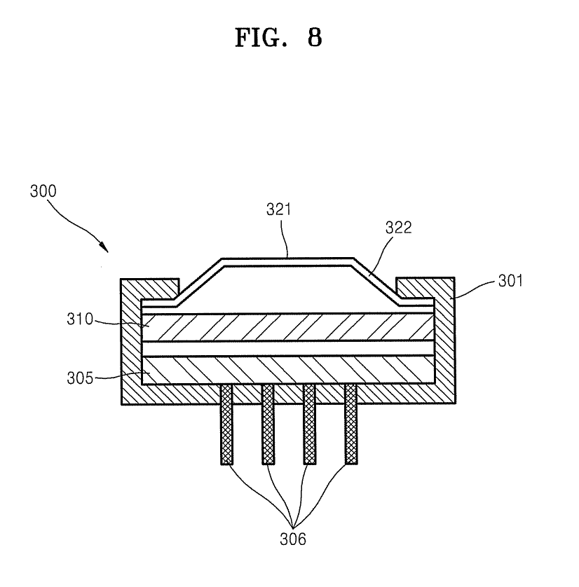

FIG. 8 is a cross-sectional view of an input element 300 according to an aspect of the present invention. Referring to FIG. 8, the input element 300 is an element that may be mounted on a circuit board of an electronic device. The input element 300 includes an input button 321, a display panel 310 disposed underneath the input button 321 to overlap with the input button 321, a circuit board 305 on which the display panel 310 is mounted, and a housing 301 including the display panel 310 and the circuit board 305.

The input button 321 is formed on a transparent flexible film 322 that is formed of a polymer or polymers. The input button 321 also protrudes when not pressed. However, when the input button 32 is pressed, the input button 321 is deformed, but is immediately elastically restored when no longer pressed. A sensing unit is formed at the transparent flexible film 322 to sense whether the input button 321 has been pressed. The sensing unit may include a piezoelectric element as illustrated in FIG. 2, a bending sensor as illustrated in FIG. 4A, a pair of resistive layers as illustrated in FIG. 7A, or a pair of electrode layers as illustrated in FIG. 7B. The display panel 310 may be an LCD panel, an OLED panel, e-paper, etc. Since signs corresponding to input orders are relatively simple, the e-paper may be used as the display panel 310 in consideration of cost. Connection terminals 306 are provided on the circuit board 305 in order for the input element 300 to be mounted on a circuit board (not shown) of an electronic device.

If the input button 321 is pressed, an image displayed on the display panel 310 may be changed from one sign (or shape) into a different sign (or shape) (e.g., from “ [symbol] ” into “▪”). The input button 321 is used to input several types of input orders corresponding to the underlying displayed image (or a sign). However, since one sign appears on the input button 321 at a time, a selection thereof may be accurately input through the input button 321.

In aspects of the present invention, the buttons need not be protruding when not pressed, and may be receding (or concave). In aspects of the present invention, the buttons may simply be markings on the flexible film or sheet. In aspects of the present invention, the input sign display areas 112 are not fixed. Accordingly, if the flexible film or sheet includes a plurality of input buttons that are arranged on the flexible film or sheet, and the flexible film or sheet is replaceable with another flexible film or sheet that has a different arrangement of a plurality of input buttons, then the display panel may have the input sign display areas aligned or correspond with the different arrangement of a plurality of input buttons.

In aspects of the present invention, the user interface device may be a remote controller as described, and can also be a telephone, a handheld device, a digital media player, or similar devices.

As described above, a user interface device according to aspects of the present invention can assist a user to tactually recognize that a user is manipulating the user interface device. Thus, the user interface device can induce the user to accurately input an input order. Also, the user interface device can be manipulated in an input method of a typical input button. Thus, users unfamiliar with touch screen input methods can easily manipulate inputs of the user interface device.

In addition, in a user interface device and an input element according to an aspect of the present invention, an input button can be used to input two or more types of orders one at a time. In this case, only an input order necessary at an appropriate time can be displayed on the input button for selection. As a result, the user interface device and the input element can enable easy inputs of orders using the same input button.

In various aspects, and/or and at least one of refer to alternatives chosen from available elements so as to include one or more of the elements. For example, if the elements available include elements X, Y, and Z, and/or and at least one of refers to X, Y, Z, or any combination thereof.

Although a few aspects of the present invention have been shown and described, it would be appreciated by those skilled in the art that changes may be made in this aspect without departing from the principles and spirit of the invention, the scope of which is defined in the claims and their equivalents.

What is claimed is:

1. A user interface device comprising:
at least one input button that protrudes to be deformed when pressed, and then elastically restored when no longer being pressed;
a sensing unit to sense whether the at least one input button has been pressed; and
a display panel disposed underneath the at least one input button and comprising at least one input sign display area that overlaps with the at least one input button, and which is viewable through the at least one input button.

2. The user interface device of claim 1, wherein the sensing unit comprises a piezoelectric element and/or a bending sensor that is attached to the at least one input button.

3. The user interface device of claim 1, wherein the sensing unit is formed from a pair of transparent resistive layers on corresponding inner surfaces of a pair of parallel flexible films and face each other, and the pair of parallel flexible films are separated from each other so as to contact each other at a pressed point when pressed together due to a pressure.

4. The user interface device of claim 1, wherein the sensing unit is formed from a pair of transparent electrode layers separated by a flexible film whose capacitance is changed when the transparent electrode layers are pressed together.

5. The user interface device of claim 1, wherein the input sign display area displays an image, which is changed when the at least one input button is pressed.

6. The user interface device of claim 1, wherein the display panel is a liquid crystal display (LCD) panel, an organic light emitting diode (OLED) panel, e-paper, or combinations thereof.

7. The user interface device of claim 1, wherein the at least one input button comprises a polymer.

8. An input element mounted on a circuit board of an electronic device, the input element comprising:
at least one input button that protrudes to be deformed when pressed, and then elastically restored when no longer being pressed;
a sensing unit to sense whether the at least one input button has been pressed; and
a display panel disposed underneath the at least one input button to overlap with the at least one input button and to change an image that is displayed when the at least one input button is pressed, and which is viewable through the at least one input button.

9. The input element of claim 8, wherein the sensing unit comprises a piezoelectric element and/or a bending sensor that is attached to the at least one input button.

10. The input element of claim 8, wherein the sensing unit is formed from a pair of transparent resistive layers on corresponding inner surfaces of a pair of parallel flexible films and face each other, and the pair of parallel flexible films are separated from each other so as to contact each other at a pressed point when pressed together due to a pressure.

11. The input element of claim 8, wherein the sensing unit is formed from a pair of transparent electrode layers that are separated by a flexible film whose capacitance is changed when the transparent electrode layers are pressed together.

12. The input button of claim 8, wherein the display panel is a liquid crystal display (LCD) panel, an organic light emitting diode (OLED) panel, e-paper, or combinations thereof.

13. The input element of claim 8, wherein the at least one input button comprises a polymer.

14. A user input device, comprising:
a flexible sheet comprising a deformable input button;
a sensing unit attached to the at least one input button to sense whether the at least one input button is deformed; and
a display panel disposed adjacent to the flexible sheet, the display panel comprising at least one input sign display area that corresponds to the at least one input button, and which displays an input image viewable through the least one input button.

15. The user input device of claim 14, wherein, when the at least one input button is pressed, a function corresponding to the input image is selected.

16. The user input device of claim 14, wherein the input image is one of a plurality of input images that is selectable one at a time by pressing the at least one input button.

17. The user input device of claim 16, wherein only one of a plurality of input images are displayed on the at least one input button at a time.

18. The user input device of claim 14, wherein the flexible sheet includes a plurality of input buttons that are arranged on the flexible sheet, and the flexible sheet is replaceable with another flexible sheet that has a different arrangement of a plurality of input buttons.

19. A method of selecting an input image using an input button, comprising:
displaying the input image on a display panel to be viewed through the input button;
selectively deforming the input button to select the input image;
switching the display of the input image to display another input image on the display panel to be viewed through the input button; and
selectively deforming the input button to select the another input image.

20. The method of claim 19, wherein the input image and the another input image are displayed at different times on an input sign display area of the display panel that corresponds to the input button.
